(19) United States
(12) Patent Application Publication
(10) Pub. No.: US 2022/0033699 A1
(43) Pub. Date: Feb. 3, 2022

(54) SELF-ORIENTING SHAPED ABRASIVE PARTICLES

(71) Applicant: 3M INNOVATIVE PROPERTIES COMPANY, St. Paul, MN (US)

(72) Inventors: Fay T. Salmon, Eden Prairie, MN (US); Cory M. Arthur, Eagan, MN (US); David T. Buckley, Falcon Heights, MN (US); Thomas J. Nelson, Woodbury, MN (US); Joseph B. Eckel, Vadnais Heights, MN (US); Emily L. Bowen, St. Paul, MN (US); Dwight D. Erickson, Woodbury, MN (US); Wayne W. Maurer, Lakeville, MN (US); Henry M. O'Callaghan, St. Paul, MN (US)

(21) Appl. No.: 17/309,437

(22) PCT Filed: Dec. 4, 2019
(86) PCT No.: PCT/IB2019/060457

§ 371 Date: May 27, 2021

Related U.S. Application Data
(60) Provisional application No. 62/776,720, filed on Dec. 7, 2018.

(51) Int. Cl. C09K 3/14

(52) U.S. Cl. CPC C09K 3/1409

(57) ABSTRACT

Various embodiments disclosed relate to a shaped abrasive particle. The shaped abrasive particle includes a first non-planar continuous surface and a second non-planar continuous surface. The shaped abrasive particle further includes at least one sidewall or edge joining the first non-planar continuous surface and the second non-planar continuous surface. The shaped abrasive particle further includes one or more vertices. The shaped abrasive particle is configured to have a stable resting position on a substantially planar substrate, wherein at least one vertex is oriented in a substantially upward direction relative to the planar substrate.

### BACKGROUND

Abrasive particles and abrasive articles including the abrasive particles are useful for abrading, finishing, or grinding a wide variety of materials and surfaces in the manufacturing of goods. As such, there continues to be a need for improving the cost, performance, or life of abrasive particles or abrasive articles.

### SUMMARY OF THE DISCLOSURE

The present disclosure provides a shaped abrasive particle. The shaped abrasive particle includes a first non-planar continuous surface and a second non-planar continuous surface. The shaped abrasive particle further includes at least one sidewall or edge joining the first non-planar continuous surface and the second non-planar continuous surface. The shaped abrasive particle further includes one or more vertices. The shaped abrasive particle is configured to have a stable resting position on a substantially planar substrate, wherein at least one vertex is oriented in a substantially upward direction relative to the planar substrate.

The present disclosure further provides a shaped abrasive particle including a curved portion. The shaped abrasive particle further includes a linear portion extending from the curved portion, the linear portion defines at least one vertex. A center of gravity of the abrasive particle is located in the curved portion.

The present disclosure further provides a twisted shaped abrasive particle. The twisted shaped abrasive particle includes a first portion comprising a first edge defining first and second vertices. The twisted shaped abrasive particle further includes a second portion connected to the first portion and comprising a second edge defining third and fourth vertices. The first portion is twisted relative to the second portion such that only three of the first, second, third and fourth vertices can be located in a single plane.

The present disclosure further provides a bent shaped abrasive particle. The bent shaped abrasive particle includes a first portion comprising a first edge defining a first vertex. The bent shaped abrasive particle further includes a second portion connected to the first portion and comprising a second edge defining a second vertex. The first portion is bent relative to the second portion such that a dihedral angle between the first portion and the second portion is in a range of from about 45 degrees to about 179 degrees.

The present disclosure further provides a method of making a shaped abrasive particle. The shaped abrasive particle includes a first non-planar continuous surface and a second non-planar continuous surface. The first and second continuous surfaces may include a feature such as a hole, recess, or cavity. The shaped abrasive particle further includes at least one sidewall or edge joining the first non-planar continuous surface and the second non-planar continuous surface. The shaped abrasive particle further includes one or more vertices. The shaped abrasive particle is configured to have a stable resting position on a substantially planar substrate, wherein at least one vertex is oriented in a substantially upward direction relative to the planar substrate. The method includes disposing an abrasive particle precursor composition in a cavity of a mold. The cavity conforms to the negative image of the shaped abrasive particle. The method further includes drying the abrasive particle precursor to form the shaped abrasive particle.

The present disclosure further provides a method of making a shaped abrasive particle. The shaped abrasive particle includes a first non-planar continuous surface and a second non-planar continuous surface. The shaped abrasive particle further includes at least one sidewall or edge joining the first non-planar continuous surface and the second non-planar continuous surface. The shaped abrasive particle further includes one or more vertices. The shaped abrasive particle is configured to have a stable resting position on a substantially planar substrate, wherein at least one vertex is oriented in a substantially upward direction relative to the planar substrate. The method includes extruding the abrasive particle precursor through a die.

The present disclosure further provides a method of making a shaped abrasive particle. The shaped abrasive particle includes a first non-planar continuous surface and a second non-planar continuous surface. The shaped abrasive particle further includes at least one sidewall or edge joining the first non-planar continuous surface and the second non-planar continuous surface. The shaped abrasive particle further includes one or more vertices. The shaped abrasive particle is configured to have a resting position on a substantially planar substrate, wherein at least one vertex is oriented in a substantially upward direction relative to the planar substrate. The method includes additively manufacturing the shaped abrasive particle.

The present disclosure further provides an abrasive article. The abrasive article includes a backing. The abrasive article further includes a plurality of shaped abrasive particles adhered to the backing. The shaped abrasive particle includes a first non-planar continuous surface and a second non-planar continuous surface. The shaped abrasive particle further includes at least one sidewall or edge joining the first non-planar continuous surface and the second non-planar continuous surface. The shaped abrasive particle further includes one or more vertices. The shaped abrasive particle is configured to have a resting position on a substantially planar substrate, wherein at least one vertex is oriented in a substantially upward direction relative to the backing.

The present disclosure further provides a method of making an abrasive article. The abrasive article includes a backing. The abrasive article further includes a plurality of shaped abrasive particles adhered to the backing. The shaped abrasive particle includes a first non-planar continuous surface and a second non-planar continuous surface.

The shaped abrasive particle further includes at least one sidewall or edge joining the first non-planar continuous surface and the second non-planar continuous surface. The shaped abrasive particle further includes one or more vertices. The shaped abrasive particle is configured to have a resting position on a substantially planar substrate, wherein at least one vertex is oriented in a substantially upward direction relative to the backing. The method includes controllably orienting the shaped abrasive particles and adhering the shaped abrasive particles to the backing.

The present disclosure further provides a method of using an abrasive article. The abrasive article includes a backing. The abrasive article further includes a plurality of shaped abrasive particles adhered to the backing. The shaped abrasive particle includes a first non-planar continuous surface and a second non-planar continuous surface. The shaped abrasive particle further includes at least one sidewall or edge joining the first non-planar continuous surface and the second non-planar continuous surface. The shaped abrasive particle further includes one or more vertices. The shaped abrasive particle is configured to have a resting position on a substantially planar substrate, wherein at least one vertex is oriented in a substantially upward direction relative to the backing. The method includes contacting the shaped abrasive particles with a workpiece. The method further includes moving at least one of the abrasive article and the workpiece relative to each other. The method further includes removing a portion of the workpiece.

There are many non-limiting reasons to use the shaped abrasive particles of the instant disclosure. For example, according to several embodiments, the shaped abrasive particles are able to self-orient on a substrate such that at least one vertex is pointing in an upward direction. The orientation of these particles can be accomplished simply by dropping the shaped abrasive particles on a backing. There is no need to go through additional steps such as, electrostatic dropping, or disposing shaped abrasive particles in a production tool, or the like to achieve a desired orientation. Additionally, according to several embodiments, the shaped abrasive particles are able to self-sharpen as the vertex is fractured. According to some embodiments, the shaped abrasive particles can provide enhanced grinding performance and increased grinding life. According to some embodiments, the shaped abrasive particles can provide a desired rake angle for cutting. The preferred rake angle can be positive, negative, or zero rake angle.

### BRIEF DESCRIPTION OF THE FIGURES

The drawings illustrate generally, by way of example, but not by way of limitation, various embodiments discussed in the present document.

FIG. 1A is a perspective view of a rounded shaped abrasive particle, in accordance with various embodiments.

FIG. 1B is a perspective view of the rounded shaped abrasive particle of FIG. 1A rotated 90 degrees about a z-axis, in accordance with various embodiments.

FIG. 1C is a side view of a rounded shaped abrasive particle, in accordance with various embodiments resting in its stable position.

FIG. 1D is a side view of the rounded shaped abrasive particle of FIG. 1C having a vertex offset from a z-axis, in accordance with various embodiments.

FIG. 1E is a side view of the rounded shaped abrasive particle of FIG. 1C rotated 45 degrees about a z-axis, in accordance with various embodiments.

FIG. 2A is a perspective view of a twisted abrasive particle, in accordance with various embodiments.

FIG. 2B is a perspective view of the twisted abrasive particle of FIG. 2A rotated 90 degrees about a z-axis, in accordance with various embodiments.

FIG. 2C is an end view of a twisted abrasive particle, in accordance with various embodiments.

FIG. 3A is a perspective view of a bent abrasive particle resting on a region of a continuous non-planar surface, in accordance with various embodiments.

FIG. 3B is a perspective view of a bent abrasive particle resting on a sidewall, in accordance with various embodiments.

FIG. 3C is a side view of a bent abrasive particle resting on a region of a continuous non-planar surface, in accordance with various embodiments.

FIG. 3D is a side view of the bent abrasive particle of FIG. 3C rotated 90 degrees about a z-axis, in accordance with various embodiments.

FIGS. 4A-4B are schematic diagrams of shaped abrasive particles having a planar trigonal shape, in accordance with various embodiments.

FIGS. 5A-5E are schematic diagrams of shaped abrasive particles having a tetrahedral shape, in accordance with various embodiments.

FIG. 6 is a screenshot showing the shaped abrasive particles of Example 1, in their resting position, according to various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As described herein the term “stable resting position” refers to the position that any shaped abrasive particle is able to achieve if subjected to no more than gravitational forces and dropped onto a planar surface. Each of the shaped abrasive particles described herein as 100A, 100B, and 100C is able to achieve one stable resting position in which at least one vertex is oriented in a substantially upward direction.

Various embodiments of the present disclosure are directed to shaped abrasive particles. Shaped abrasive particles disclosed herein include at least a first non-planar continuous surface and a second non-planar continuous surface. While each surface is non-planar, each surface is free of a geometric infliction point of about 90 degrees, which breaks the continuity of the respective non-planar surface. The first and second non-planar continuous surfaces are joined to each other by at least one sidewall or edge. One or more vertices of the shaped abrasive particle are formed by the at least one sidewall or edge of the shaped abrasive particle. The shaped abrasive particles are configured such that in a resting position on a substantially planar substrate, at least one vertex is oriented in a substantially upward direction relative to the planar substrate.

The shaped abrasive particles described herein can include any suitable material or mixture of materials. For example, the shaped abrasive particles independently can comprise a ceramic material or a polymeric material. If the shaped abrasive particles comprise a ceramic material, the ceramic material can include alpha alumina, sol-gel derived alpha alumina, or a mixture thereof. Other suitable materials include a fused aluminum oxide, a heat-treated aluminum oxide, a ceramic aluminum oxide, a sintered aluminum oxide, a silicon carbide material, a titanium diboride, a boron carbide, a tungsten carbide, a titanium carbide, a diamond, a cubic boron nitride, a garnet, a fused alumina-zirconia, a cerium oxide, a zirconium oxide, a titanium oxide or a combination thereof.

Some shaped abrasive particles can include a polymeric material and can be characterized as soft abrasive particles. The soft shaped abrasive particles described herein can independently include any suitable material or combination of materials. For example, the soft shaped abrasive particles can include a reaction product of a polymerizable mixture including one or more polymerizable resins. The one or more polymerizable resins such as a hydrocarbyl polymerizable resin. Examples of such resins include those chosen from a phenolic resin, a urea formaldehyde resin, a urethane resin, a melamine resin, an epoxy resin, a bismaleimide resin, a vinyl ether resin, an aminoplast resin (which may include pendant alpha, beta unsaturated carbonyl groups), an acrylate resin, an acrylated isocyanurate resin, an isocyanurate resin, an acrylated urethane resin, an acrylated epoxy resin, an alkyl resin, a polyester resin, a drying oil, or mixtures thereof. The polymerizable mixture can include additional components such as a plasticizer, an acid catalyst, a cross-linker, a surfactant, a mild-abrasive, a pigment, a catalyst and an antibacterial agent.

Where multiple components are present in the polymerizable mixture, those components can account for any suitable weight percentage of the mixture. For example, the polymerizable resin or resins, may be in a range of from about 35 wt % to about 99.9 wt % of the polymerizable mixture, about 40 wt % to about 95 wt %, or less than, equal to, or greater than about 35 wt %, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or about 99.9 wt %.

If present, the cross-linker may be in a range of from about 2 wt % to about 60 wt % of the polymerizable mixture, from about 5 wt % to about 10 wt %, or less than, equal to, or greater than about 2 wt %, 3, 4, 5, 6, 7, 8, 9, 10, 11, 12, 13, 14, or about 15 wt %. Examples of suitable cross-linkers include a cross-linker available under the trade designation CYMEL 303 LF, of Allnex USA Inc., Alpharetta, Ga., USA; or a cross-linker available under the trade designation CYMEL 385, of Allnex USA Inc., Alpharetta, Ga., USA.

If present, the mild-abrasive may be in a range of from about 5 wt % to about 65 wt % of the polymerizable mixture, about 10 wt % to about 20 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or about 65 wt %. Examples of suitable mild-abrasives include a mild-abrasive available under the trade designation MINSTRON 353 TALC, of Imerys Talc America, Inc., Three Forks, Mont., USA; a mild-abrasive available under the trade designation USG TERRA ALBA NO. 1 CALCIUM SULFATE, of USG Corporation, Chicago, Ill., USA; Recycled Glass (40-70 Grit) available from ESCA Industries, Ltd., Hatfield, Pa., USA, silica, calcite, nepheline, syenite, calcium carbonate, or mixtures thereof.

If present, the plasticizer may be in a range of from about 5 wt % to about 40 wt % of the polymerizable mixture, about 10 wt % to about 15 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or about 40 wt %. Examples of suitable plasticizers include acrylic resins or styrene butadiene resins. Examples of acrylic resins include an acrylic resin available under the trade designation RHOPLEX GL-618, of DOW Chemical Company, Midland, Mich., USA; an acrylic resin available under the trade designation HYCAR 2679, of the Lubrizol Corporation, Wickliffe, Ohio, USA; an acrylic resin available under the trade designation HYCAR 26796, of the Lubrizol Corporation, Wickliffe, Ohio, USA; a polyether polyol available under the trade designation ARCOL LG-650, of DOW Chemical Company, Midland, Mich., USA; or an acrylic resin available under the trade designation HYCAR 26315, of the Lubrizol Corporation, Wickliffe, Ohio, USA. An example of a styrene butadiene resin includes a resin available under the trade designation ROVENE 5900, of Mallard Creek Polymers, Inc., Charlotte, N.C., USA.

If present, the acid catalyst may be in a range of from 1 wt % to about 20 wt % of the polymerizable mixture, about 5 wt % to about 10 wt %, or less than, equal to, or greater than about 1 wt %, 2, 3, 4, 5, 6, 7, 8, 9, 10, 11, 12, 13, 14, 15, 16, 17, 18, 19, or about 20 wt %. Examples of suitable acid catalysts include a solution of aluminum chloride or a solution of ammonium chloride.

If present, the surfactant can be in a range of from about 0.001 wt % to about 15 wt % of the polymerizable mixture about 5 wt % to about 10 wt %, less than, equal to, or greater than about 0.001 wt %, 0.01, 0.5, 1, 2, 3, 4, 5, 6, 7, 8, 9, 10, 11, 12, 13, 14, or about 15 wt %. Examples of suitable surfactants include a surfactant available under the trade designation GEMTEX SC-85-P, of Innospec Performance Chemicals, Salisbury, N.C., USA; a surfactant available under the trade designation DYNOL 604, of Air Products and Chemicals, Inc., Allentown, Pa., USA; a surfactant available under the trade designation ACRYSOL RM-8W, of DOW Chemical Company, Midland, Mich., USA; or a surfactant available under the trade designation XIAMETER AFE 1520, of DOW Chemical Company, Midland, Mich., USA.

If present, the antimicrobial agent may be in a range of from 0.5 wt % to about 20 wt % of the polymerizable mixture, about 10 wt % to about 15 wt %, or less than, equal to, or greater than about 0.5 wt %, 1, 2, 3, 4, 5, 6, 7, 8, 9, 10, 11, 12, 13, 14, 15, 16, 17, 18, 19, or about 20 wt %. An example of a suitable antimicrobial agent includes zinc pyrithione.

If present, the pigment may be in a range of from about 0.1 wt % to about 10 wt % of the polymerizable mixture, about 3 wt % to about 5 wt %, less than, equal to, or greater than about 0.1 wt %, 0.2, 0.4, 0.6, 0.8, 1, 1.5, 2, 2.5, 3, 3.5, 4, 4.5, 5, 5.5, 6, 6.5, 7, 7.5, 8, 8.5, 9, 9.5, or about 10 wt %. Examples of suitable pigments include a pigment dispersion available under the trade designation SUNSPERSE BLUE 15, of Sun Chemical Corporation, Parsippany, N.J., USA; a pigment dispersion available under the trade designation SUNSPERSE VIOLET 23, of Sun Chemical Corporation, Parsippany, N.J., USA; a pigment dispersion available under the trade designation SUN BLACK, of Sun Chemical Corporation, Parsippany, N.J., USA; or a pigment dispersion available under the trade designation BLUE PIGMENT B2G, of Clariant Ltd., Charlotte, N.C., USA. The mixture of components can be polymerized by curing.

In addition to the materials already described, at least one magnetic material may be included within or coated to the shaped abrasive particles. Examples of magnetic materials include iron; cobalt; nickel; various alloys of nickel and iron marketed as Permalloy in various grades; various alloys of iron, nickel and cobalt marketed as Fernico, Kovar, FerNiCo I, or FerNiCo II; various alloys of iron, aluminum, nickel, cobalt, and sometimes also copper and/or titanium marketed as Alnico in various grades; alloys of iron, silicon, and aluminum (about 85:9:6 by weight) marketed as Sendust alloy; Heusler alloys (e.g., Cu₂MnSn); manganese bismuthide (also known as Bismanol); rare earth magnetizable materials such as gadolinium, dysprosium, holmium, europium oxide, alloys of neodymium, iron and boron (e.g., Nd₂Fe₁₄B), and alloys of samarium and cobalt (e.g., SmCo₅); MnSb; MnOFe₂O₃; Y₃Fe₅O₁₂; CrO₂; MnAs; ferrites such as ferrite, magnetite; zinc ferrite; nickel ferrite; cobalt ferrite, magnesium ferrite, barium ferrite, and strontium ferrite; yttrium iron garnet; and combinations of the foregoing. In some embodiments, the magnetizable material is an alloy containing 8 to 12 weight percent aluminum, 15 to 26 wt % nickel, 5 to 24 wt % cobalt, up to 6 wt % copper, up to 1% titanium, wherein the balance of material to add up to 100 wt % is iron. In some other embodiments, a magnetizable coating can be deposited on an abrasive particles 100A, 100B, 100C using a vapor deposition technique such as, for example, physical vapor deposition (PVD) including magnetron sputtering.

Including these magnetizable materials can allow shaped abrasive particles to be responsive a magnetic field. Any of the shaped abrasive particles can include the same material or include different materials.

The vertices of any one of the shaped abrasive particles can have any suitable sharpness. One way to characterize the sharpness of the vertices is by measuring the radius of curvature of the one or more vertices. In some embodiments, the radius of curvature of the one or more vertices is independently in a range of from about 0.1 μm to about 200 μm, about 0.5 μm to 40 μm, less than, equal to, or greater than about 0.1 μm, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or about or about 500 μm.

The shaped abrasive particles can be designed to have any suitable thickness measured from the first non-planar surface to the second non-planar surface. For example, the thickness can be in a range of from about 0.005 mm to 5 mm, about 0.02 mm to 2 mm, less than, equal to, or greater than about 0.005 mm, 0.25, 0.50, 0.75, 1, 1.25, 1.50, 1.75, 2, 2.25, 2.50, 2.75, 3, 3.25, 3.50, 3.75, 4, 4.25, 4.50, 4.75 or about 5 mm. Additionally, any edge or sidewall can have any suitable length. For example, a length of the edges may be in a range of from about 0.5 μm to about 2000 μm, about 150 μm to about 200 μm, or less than, equal to, or greater than about 0.5 μm, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000 μm.

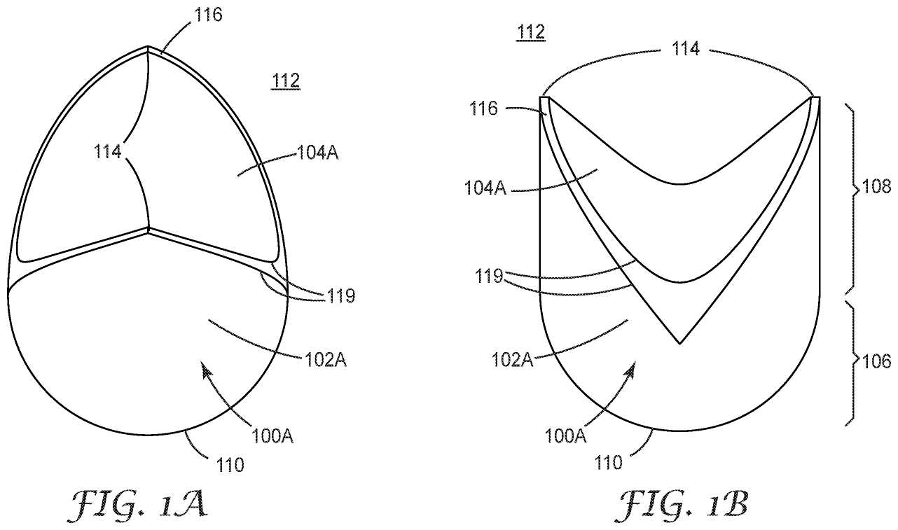

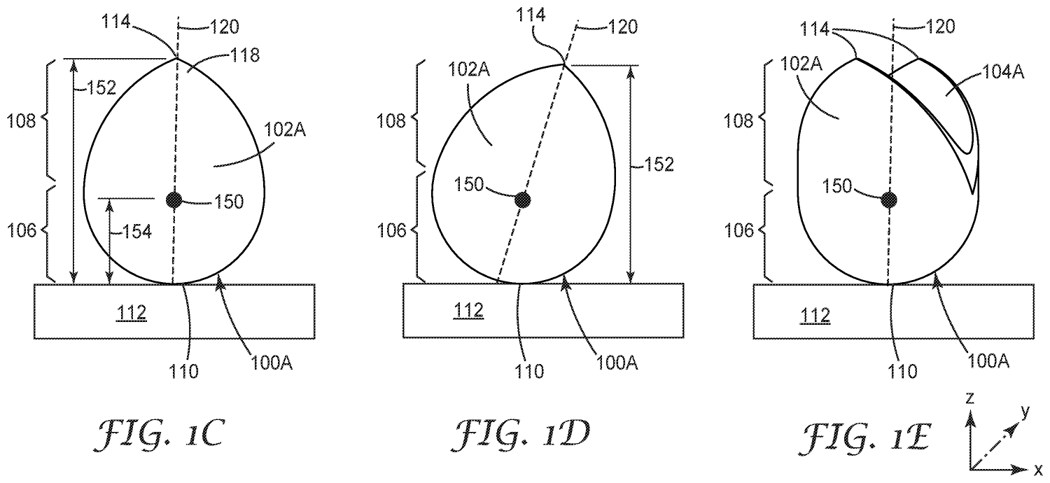

FIGS. 1A-1E show embodiments of rounded shaped abrasive particle 100A. FIGS. 1A-1E show many of the same components and are discussed concurrently. As shown in FIGS. 1A-1E, first continuous surface 102A and second continuous surface 104A have a curved profile in which a cross-sectional shape (taken in the x-y direction) of particle 100A generally conforms to a cylindrical shape. The generally cylindrical shape can conform to a symmetric circular shape or an asymmetric circular shape (e.g., an oval or ellipse).

As shown in FIGS. 1A-1E the curved profile includes curved region 106 and linear region 108. Curved region 106 can have a hemi-spherical shape, which can account for about 5 percent surface area to about 70 percent surface area of shaped abrasive particle 100A, about 25 percent surface area to about 50 percent surface area, less than, equal to, or greater than about 5 percent surface area, 10, 15, 20, 25, 30, 35, 40, 45, 50, 55, 60, 65, or about 70 percent surface area. Linear region 108 can account for about 5 percent surface area to about 70 percent surface area of shaped abrasive particle 100A, about 25 percent surface area to about 50 percent surface area, less than, equal to, or greater than about 5 percent surface area, 10, 15, 20, 25, 30, 35, 40, 45, 50, 55, 60, 65, or about 70 percent surface area.

Shaped abrasive particle 100A is designed such that bottom end 110 is located within curved region 106. In the stable resting position, bottom end 110 is in contact with substrate 112. Substrate 112 can be a backing of an abrasive article. In these embodiments, substrate 112 can be flexible or rigid. Examples of suitable materials for forming a flexible backing include a polymeric film, a metal foil, a woven fabric, a knitted fabric, paper, vulcanized fiber, a staple fiber, a continuous fiber, a nonwoven, a foam, a screen, a laminate, an organic material such as wood, leather, and combinations thereof. Substrate 112 can be shaped to allow an abrasive article to be in the form of sheets, discs, belts, pads, or rolls. In some embodiments, substrate 112 can be sufficiently flexible to allow an abrasive article to be formed into a loop to make an abrasive belt that can be run on suitable grinding equipment.

To help to ensure that bottom end 110 is in contact with substrate 112, shaped abrasive particle 100A can be designed such that a center of gravity is located within curved region 106. Although the center of gravity is located within curved region 106, the geometric center of gravity is not necessarily located in curved region 106. Shaped abrasive particle 100A can be designed such that the geometric center of particle 100A can be located in curved region 106, linear region 108, or at an interface therebetween.

Vertices 114 are located at top end 116 of shaped abrasive particle 100A opposite of bottom end 110. Vertices 114 are formed by sidewalls 119, which join surfaces 102A and 104A. As shown, shaped abrasive particle 100A includes two vertices 114. In other embodiments, however, shaped abrasive particle 100A, can include as few as one vertex 114, or any plural number of vertices 114.

As mentioned herein, in the resting position, at least one of vertices 114 are oriented in a substantially upward direction relative to the planar substrate. The degree to which an individual vertex is oriented in an upward direction can be characterized by distance 152 measured from any one of the vertices 114 to the surface of substrate 112 being greater than the distance measured from center of gravity 150 to the surface of substrate 112. In some embodiments, shaped abrasive particle 100A can have vertex 114 offset from being oriented in a fully upright position. This is shown in FIG. 1D where distance 152 from vertex 114 to the substrate 112 is greater than distance 154 from the center of gravity to the substrate 112, but only about 95%, 90%, 85%, 80%, or 75% of distance 152 from the vertex 114 to the substrate 112 when the particle is in the fully upright position. The value of distance 152 from vertex 114 to substrate 112 can be any suitable value, for example distance 152 between vertex 114 and substrate 112 can be greater than about 101% or in a range of from about 101% to about 10,000%, of the distance 154 from center of gravity 150 to the substrate 112 to the full distance from the vertices 114 to the substrate 112 when the particle is in the fully upright position.

In addition to controlling the degree to which vertices 114 are pointing upward, shaped abrasive particle 100A can be rotated on substrate 112 about line 120 to any suitable degree. For example, as shown in FIG. 1E, shaped abrasive particle 100A is rotated about line 120 by about 45 degrees. Although a rotation of about 45 degrees is shown, shaped abrasive particle 100A can be rotated by any suitable amount between 0 degrees and 360 degrees such as from about 10 degrees to about 170 degrees, about 45 degrees to about 135 degrees, about 70 degrees to about 110 degrees, less than, equal to, or greater than about 5 degrees, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, or about 170 degrees.

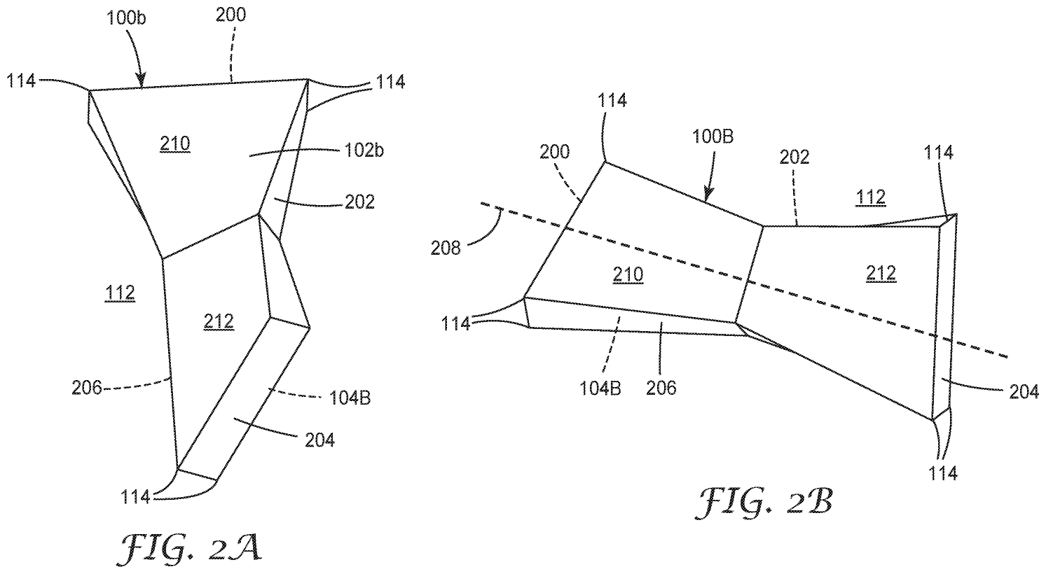

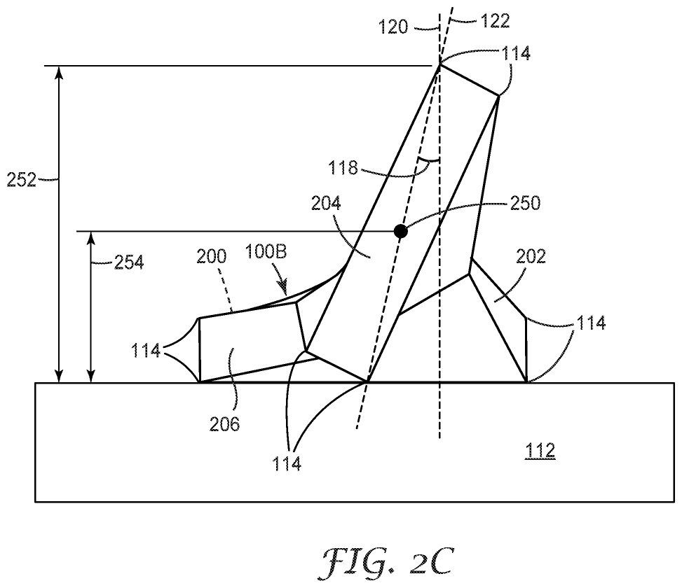

FIGS. 2A-2C illustrate shaped abrasive particle 100B. As shown in FIGS. 2A-2C, shaped abrasive particle 100B, is formed from first non-planar continuous surface 102B and second non-planar continuous surface 104B. Surfaces 102B and 104B are joined by sidewalls 200, 202, 204, and 206 each of which form two vertices 114 at an intersection therebetween.

Shaped abrasive particle 100B is twisted about longitudinal axis 208 to form first region 210 and second region 212. The twist results in a dihedral angle being formed between first region 210 and second region 212, which is in a range of from about 5 degrees to about 170 degrees, about 20 degrees to about 90 degrees, less than, equal to, or greater than about 5 degrees, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, or about 170 degrees.

As shown in FIGS. 2A and 2B, each or first region 210 and second region 212 account for about 50 percent of the total surface area of shaped abrasive particle 100B. As a result, a change in the curvature of first non-planar continuous surface 102B and second non-planar continuous surface 104B is located at a midpoint of shaped abrasive particle 100B, measured along axis 208. In further embodiments of shaped abrasive particle 100B, however, first region 210 and second region 212 can independently be in a range of from about 5 percent surface area to about 95 percent surface area of shaped abrasive particle 100B, about 25 percent surface area to about 50 percent surface area, less than, equal to, or greater than about 5 percent surface area, 10, 15, 20, 25, 30, 35, 40, 45, 50, 55, 60, 65, 70, 75, 80, 85, 90, or about 95 percent surface area.

Shaped abrasive particle 100B can conform to one of many different shapes. The shape can be determined by characterizing the cross-sectional shape of shaped abrasive particle 100B taken along central axis 208. For example, first region 210 and second region 212 can independently comprise a quadrilateral cross-sectional shape. The quadrilateral cross-sectional shape can substantially conform to a square, rectangle, or trapezoid. Alternatively, first region 210 and second region 212 can independently have a substantially triangular cross-sectional shape. The triangular shape can substantially conform to an equilateral triangle, a right triangle, a scalene triangle, an isosceles triangle, an acute triangle, or an obtuse triangle. In some embodiments of shaped abrasive particle 100B, a cross-sectional area value can differ across the length of shaped abrasive particle 100B measured along axis 108. In other embodiments, the cross-sectional shape can conform to any higher order polygonal shape.

As shown in FIGS. 2A-2C, in the resting position, three of vertices 114 are in contact with substrate 112. This leaves at least one vertex 114 pointing in a substantially upward direction. The substantially upward direction is shown in FIG. 2C, where distance 252 from vertex 114 to the substrate 112 is greater than distance 254 from center of gravity 250 to the substrate 112. Further, as shown in FIG. 2C, line 120 is perpendicular to substrate 112 and passes through apex vertex 114 that is pointing upward. Another line, 122, passes through the same apex vertex 114 and the vertex that is in contact with the substrate. This vertex 114 contacting with the substrate 112 is in the same region (in region 210 or region 212) of the apex vertex 114. Angle 118, is formed between the line 120 and the line 122. The substantially upward direction is shown in FIG. 2C, where the angle 118 is between zero and 85 degrees. In some embodiments, shaped abrasive particle 100B can have vertex 114 offset from being oriented in a fully upright position. The value of angle 118 can be any suitable value, for example, angle 118 can be in a range of from about 1 degree to about 85 degrees, about 1 degrees to about 45 degrees, less than, equal to, about 1 degree, 5, 10, 15, 20, 25, 30, 35, 40, 45, 50, 55, 60, 65, 70, 75, 80, or about 85 degrees

In addition to controlling the degree to which vertices 114 are pointing upward, shaped abrasive particle 100B, can be rotated on substrate 112 about line 120 or any other line perpendicular to substrate 112 and passing though shaped abrasive particle 100B, to any suitable degree. For example, shaped abrasive particle 100B can be rotated about line 120 by any suitable amount such as from about 5 degrees to about 185 degrees, about 45 degrees to about 135 degrees, about 70 degrees to about 110 degrees, less than, equal to, or greater than about 5 degrees, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, or about 185 degrees. Although one resting position is shown with first non-planar continuous surface 102B oriented away from substrate 112, shaped abrasive particle 100B can also be oriented in a second resting position in which second non-planar continuous surface 104B is oriented away from substrate 112.

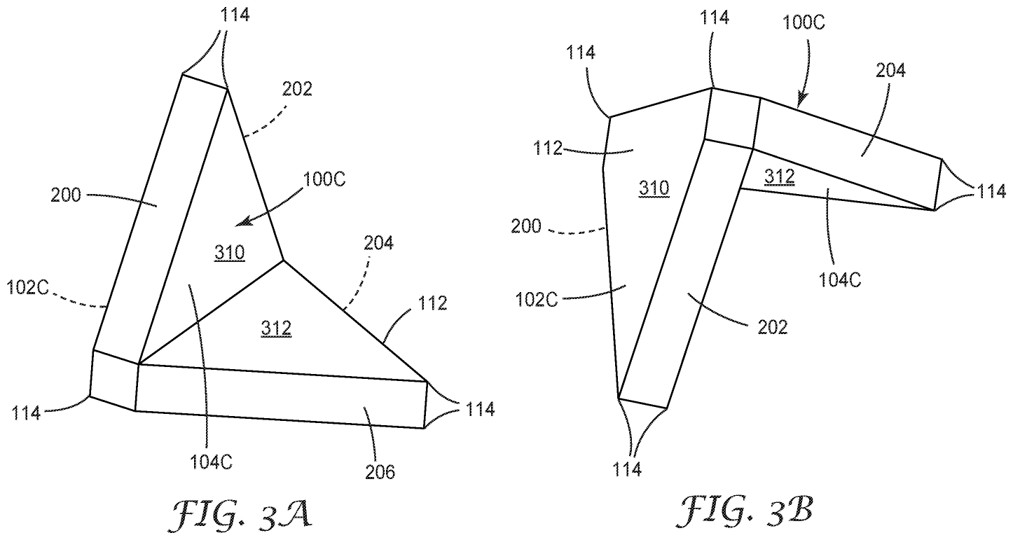

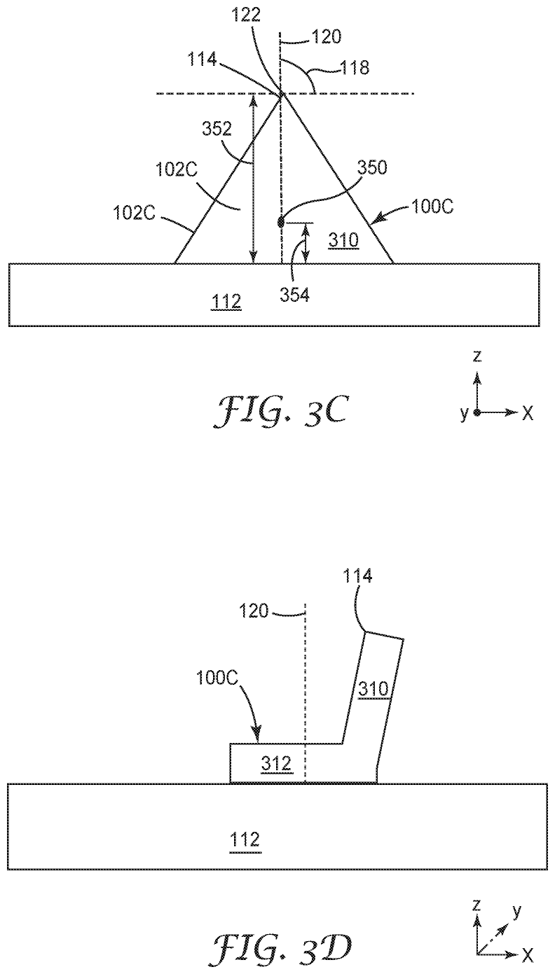

FIGS. 3A-3C illustrate shaped abrasive particle 100C. As shown, shaped abrasive particle 100C includes first continuous non-planar surface 102C and second continuous non-planar surface 104C. Surfaces 102C and 104C are joined by sidewalls 200, 202, 204, and 206 each of which form one or two vertices 114 at an intersection therebetween.

Shaped abrasive particle 100C has a bend to form first region 310 and second region 312. The bend results in a dihedral angle measured between first region 310 and second region 312. This dihedral angle is in a range of from about 30 degrees to about 179 degrees with respect to each other, about 45 degrees to about 90 degrees, less than, equal to, or greater than about 45 degrees, 45, 50, 60, 75, 80, 85, 90, 95, 100, 105, 110, 115, 120, 125, 130, 135, 140, 145, 150, 155, 160, 165, 170, 175, or about 179 degrees. A radius of curvature measured across the bend can be in a range of from about 0.01 mm to 10 mm.

As shown in FIGS. 3A and 3B, each of first region 310 and second region 312 account for about 50 percent of the total surface area of shaped abrasive particle 100C. As a result, an inflection point on first non-planar continuous surface 102C and second non-planar continuous surface 104C is located at a midpoint of shaped abrasive particle 100C. In further embodiments, of shaped abrasive particle 100C, however, first region 310 and second region 312 can independently be in a range of from about 5 percent surface area to about 95 percent surface area of shaped abrasive particle 100C, about 25 percent surface area to about 50 percent surface area, less than, equal to, or greater than about 5 percent surface area, 10, 15, 20, 25, 30, 35, 40, 45, 50, 55, 60, 65, 70, 75, 80, 85, 90, or about 95 percent surface area.

Shaped abrasive particle 100C can conform to one of many different shapes. The shape can be determined by characterizing the cross-sectional shape of shaped abrasive particle 100C. For example, first region 310 and second region 312 can independently comprise a quadrilateral cross-sectional shape. For example, the quadrilateral cross-sectional shape can substantially conform to a square, rectangle, or trapezoid. Alternatively, first region 310 and second region 312 can independently have a substantially triangular cross-sectional shape. The triangular shape can substantially conform to an equilateral triangle, a right triangle, a scalene triangle, an isosceles triangle, an acute triangle, or an obtuse triangle. The cross-sectional shape can further conform to any suitable higher order polygon such as a pentagon, a hexagon, a heptagon, or an octagon. The cross-sectional shape of the first region 310 or the second region 312 can further be the composite of different polygons, such as a triangle joined to a rectangle along their edges. In some embodiments of shaped abrasive particle 300C, a cross-sectional area value can differ across the length of shaped abrasive particle 300C. The size and shape of first region 310 and second region 312 can be substantially equivalent or non-equivalent.

As shown in FIGS. 3A and 3B, shaped abrasive particle 100C can be arranged on substrate 112 in a number of different resting positions. For example, in FIG. 3A second region 312 is in contact with substrate 112. In an alternative embodiment, first region 310 can be in contact with substrate 112. In FIG. 3B, sidewalls 200 and 206 are in contact with substrate 112. In an alternative embodiment, sidewalls 202 and 204 can be in contact with substrate 112. In any of the possible resting positions, at least one of vertices 114 can be oriented in substantially upward direction. This leaves at least one vertex 114 pointing in a substantially upward direction. The substantially upward direction is shown in FIG. 3C, distance 352 measured from the vertices 114 to the substrate 112 is greater than distance 354 measured from center of gravity 350 to the substrate surface 112. In some embodiments, shaped abrasive particle 100C can have vertex 114 offset from being oriented in a fully upright position, where the distance from vertices 114 to the substrate 112 is greater than the distance from the center of gravity to the substrate 112, but only about 99%, 95%, 90%, 85%, 80%, 75% of or less than the distance from the vertices 114 to the substrate 112 when the particle is in the fully upright position.

In addition to controlling the degree to which vertices 114 are pointing upward, shaped abrasive particle 100C, can be rotated on substrate 112 about line 120 or any other line perpendicular to substrate 112 and passing though shaped abrasive particle 100C, to any suitable degree. For example, shaped abrasive particle 100C can be rotated about line 120 by any suitable amount such as from about 5 degrees to about 185 degrees, about 45 degrees to about 135 degrees, about 70 degrees to about 110 degrees, less than, equal to, or greater than about 5 degrees, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, or about 185 degrees.

Shaped abrasive particle 100A, 100B, or 100C can be formed in many suitable manners for example, shaped abrasive particle 100A, 100B, or 100C can be made according to a multi-operation process. The process can be carried out using any material or precursor dispersion material. Briefly, for embodiments where shaped abrasive particles 100A, 100B, or 100C are monolithic ceramic particles, the process can include the operations of making either a seeded or non-seeded precursor dispersion that can be converted into a corresponding (e.g., a boehmite sol-gel that can be converted to alpha alumina); filling one or more mold cavities having the desired outer shape of shaped abrasive particles 100A, 100B, or 100C with a precursor dispersion; drying the precursor dispersion to form precursor shaped abrasive particle; removing the precursor shaped abrasive particles 100A, 100B, or 100C from the mold cavities; calcining the precursor shaped abrasive particles 100A, 100B, or 100C to form calcined, precursor shaped abrasive particle 100A, 100B, or 100C; and then sintering the calcined, precursor shaped abrasive particle 100A, 100B, or 100C to form shaped abrasive particle 100A, 100B, or 100C. The process will now be described in greater detail in the context of alpha-alumina-containing shaped abrasive particle 100A, 100B, or 100C. In other embodiments, the mold cavities may be filled with a melamine to form melamine shaped abrasive particles.

The process can include the operation of providing either a seeded or non-seeded dispersion of a precursor that can be converted into ceramic. In examples where the precursor is seeded, the precursor can be seeded with an oxide of an iron (e.g., FeO). The precursor dispersion can include a liquid that is a volatile component. In one example, the volatile component is water. The dispersion can include a sufficient amount of liquid for the viscosity of the dispersion to be sufficiently low to allow filling mold cavities and replicating the mold surfaces, but not so much liquid as to cause subsequent removal of the liquid from the mold cavity to be prohibitively expensive. In one example, the precursor dispersion includes from 2 percent to 90 percent by weight of the particles that can be converted into ceramic, such as particles of aluminum oxide monohydrate (boehmite), and at least 10 percent by weight, or from 50 percent to 70 percent, or 50 percent to 60 percent, by weight, of the volatile component such as water. Conversely, the precursor dispersion in some embodiments contains from 30 percent to 50 percent, or 40 percent to 50 percent solids by weight.

Examples of suitable precursor dispersions include zirconium oxide sols, vanadium oxide sols, cerium oxide sols, aluminum oxide sols, and combinations thereof. Suitable aluminum oxide dispersions include, for example, boehmite dispersions and other aluminum oxide hydrates dispersions. Boehmite can be prepared by known techniques or can be obtained commercially. Examples of commercially available boehmite include products having the trade designations “DISPERAL” and “DISPAL”, both available from Sasol North America, Inc., or “HIQ-40” available from BASF Corporation. These aluminum oxide monohydrates are relatively pure; that is, they include relatively little, if any, hydrate phases other than monohydrates, and have a high surface area.

The physical properties of the resulting shaped abrasive particle 100A, 100B, or 100C can generally depend upon the type of material used in the precursor dispersion. As used herein, a “gel” is a three-dimensional network of solids dispersed in a liquid.

The precursor dispersion can contain a modifying additive or precursor of a modifying additive. The modifying additive can function to enhance some desirable property of the abrasive particles or increase the effectiveness of the subsequent sintering step. Modifying additives or precursors of modifying additives can be in the form of soluble salts, such as water-soluble salts. They can include a metal-containing compound and can be a precursor of an oxide of magnesium, zinc, iron, silicon, cobalt, nickel, zirconium, hafnium, chromium, yttrium, praseodymium, samarium, ytterbium, neodymium, lanthanum, gadolinium, cerium, dysprosium, erbium, titanium, and mixtures thereof. The particular concentrations of these additives that can be present in the precursor dispersion can be varied.

The introduction of a modifying additive or precursor of a modifying additive can cause the precursor dispersion to gel. The precursor dispersion can also be induced to gel by application of heat over a period of time to reduce the liquid content in the dispersion through evaporation. The precursor dispersion can also contain a nucleating agent. Nucleating agents suitable for this disclosure can include fine particles of alpha alumina, alpha ferric oxide or its precursor, titanium oxides and titanates, chrome oxides, or any other material that will nucleate the transformation. The amount of nucleating agent, if used, should be sufficient to effect the transformation of alpha alumina.

A peptizing agent can be added to the precursor dispersion to produce a more stable hydrosol or colloidal precursor dispersion. Suitable peptizing agents are monoprotic acids or acid compounds such as acetic acid, hydrochloric acid, formic acid, and nitric acid. Multiprotic acids can also be used, but they can rapidly gel the precursor dispersion, making it difficult to handle or to introduce additional components. Some commercial sources of boehmite contain an acid titer (such as absorbed formic or nitric acid) that will assist in forming a stable precursor dispersion.

The precursor dispersion can be formed by any suitable means; for example, in the case of a sol-gel alumina precursor, it can be formed by simply mixing aluminum oxide monohydrate with water containing a peptizing agent or by forming an aluminum oxide monohydrate slurry to which the peptizing agent is added.

Defoamers or other suitable chemicals can be added to reduce the tendency to form bubbles or entrain air while mixing. Additional chemicals such as wetting agents, alcohols, or coupling agents can be added if desired. Foaming agent can be added to form bubbles to adjust the density of the particles.

A further operation can include providing a mold having at least one mold cavity, or a plurality of cavities formed in at least one major surface of the mold. In some examples, the mold is formed as a production tool, which can be, for example, a belt, a sheet, a continuous web, a coating roll such as a rotogravure roll, a sleeve mounted on a coating roll, or a die. In one example, the production tool can include polymeric material. Examples of suitable polymeric materials include thermoplastics such as polyesters, polycarbonates, poly(ether sulfone), poly(methyl methacrylate), polyurethanes, polyvinylchloride, polyolefin, polystyrene, polypropylene, polyethylene or combinations thereof, or thermosetting materials. In one example, the entire tooling is made from a polymeric or thermoplastic material. In another example, the surfaces of the tooling in contact with the precursor dispersion while the precursor dispersion is drying, such as the surfaces of the plurality of cavities, include polymeric or thermoplastic materials, and other portions of the tooling can be made from other materials. A suitable polymeric coating can be applied to a metal tooling to change its surface tension properties, by way of example. In some examples the mold or production tool is a two-part tool where one part incudes a depression and the second part includes a protrusion that at least partially fills the depression. This can be useful for forming shaped abrasive particles 100A, 100B, or 100C.

A polymeric or thermoplastic production tool can be replicated off a metal master tool. The master tool can have the inverse pattern of that desired for the production tool. The master tool can be made in the same manner as the production tool. In one example, the master tool is made out of metal (e.g., nickel) and is diamond-turned. In one example, the master tool is at least partially formed using stereolithography. The polymeric sheet material can be heated along with the master tool such that the polymeric material is embossed with the master tool pattern by pressing the two together. A polymeric or thermoplastic material can also be extruded or cast onto the master tool and then pressed. The thermoplastic material is cooled to solidify and produce the production tool. If a thermoplastic production tool is utilized, then care should be taken not to generate excessive heat that can distort the thermoplastic production tool, limiting its life.

Access to cavities can be from an opening in the top surface or bottom surface of the mold. In some examples, the cavities can extend for the entire thickness of the mold. Alternatively, the cavities can extend only for a portion of the thickness of the mold. In one example, the top surface is substantially parallel to the bottom surface of the mold with the cavities having a substantially uniform depth. At least one side of the mold, the side in which the cavities are formed, can remain exposed to the surrounding atmosphere during the step in which the volatile component is removed.

The cavities have a specified three-dimensional shape to make shaped abrasive particles 100A, 100B, or 100C. The cavity depth dimension is equal to the perpendicular distance from the top surface to the lowermost point on the bottom surface.

The depth of a given cavity can be uniform or can vary along its length and/or width. The cavities of a given mold can be of the same shape or of different shapes.

A further operation involves filling the cavities in the mold with the precursor dispersion (e.g., by a conventional technique). In some examples, a knife roll coater or vacuum slot die coater can be used. A mold release agent can be used to aid in removing the particles from the mold if desired. Examples of mold release agents include oils such as peanut oil or mineral oil, fish oil, silicones, polytetrafluoroethylene, zinc stearate, and graphite. In general, a mold release agent such as peanut oil, in a liquid, such as water or alcohol, is applied to the surfaces of the production tooling in contact with the precursor dispersion such that from about 0.1 mg/in² (0.6 mg/cm²) to about 3.0 mg/in² (20 mg/cm²), or from about 0.1 mg/in² (0.6 mg/cm²) to about 5.0 mg/in² (30 mg/cm²), of the mold release agent is present per unit area of the mold when a mold release is desired. In some embodiments, the top surface of the mold is coated with the precursor dispersion. The precursor dispersion can be pumped onto the top surface.

In a further operation, a scraper or leveler bar can be used to force the precursor dispersion fully into the cavity of the mold. The remaining portion of the precursor dispersion that does not enter the cavity can be removed from the top surface of the mold and recycled. In some examples, a small portion of the precursor dispersion can remain on the top surface, and in other examples the top surface is substantially free of the dispersion. The pressure applied by the scraper or leveler bar can be less than 100 psi (0.6 MPa), or less than 50 psi (0.3 MPa), or even less than 10 psi (60 kPa). In some examples, no exposed surface of the precursor dispersion extends substantially beyond the top surface.

In those examples where it is desired to have the exposed surfaces of the cavities result in planar faces of the shaped abrasive particles, it can be desirable to overfill the cavities (e.g., using a micronozzle array) and slowly dry the precursor dispersion.

A further operation involves removing the volatile component to dry the dispersion. The volatile component can be removed by fast evaporation rates. In some examples, removal of the volatile component by evaporation occurs at temperatures above the boiling point of the volatile component. An upper limit to the drying temperature often depends on the material the mold is made from. For polypropylene tooling, the temperature should be less than the melting point of the plastic. In one example, for a water dispersion of from about 40 to 50 percent solids and a polypropylene mold, the drying temperatures can be from about 90° C. to about 165° C., or from about 105° C. to about 150° C., or from about 105° C. to about 120° C. Higher temperatures can lead to improved production speeds but can also lead to degradation of the polypropylene tooling, limiting its useful life as a mold.

In some examples the mold can be twisted before the precursors are dried. This can impart the twist or bend in shaped abrasive particles 100B and 100C.

During drying, the precursor dispersion shrinks, often causing retraction from the cavity walls. For example, if the cavities have planar walls, then the resulting shaped abrasive particles 100A, 100B, or 100C can tend to have at least three concave major sides. It is presently discovered that by making the cavity walls concave (whereby the cavity volume is increased) it is possible to obtain shaped abrasive particles 100A, 100B, or 100C that have at least three substantially planar major sides. The degree of concavity generally depends on the solids content of the precursor dispersion.

A further operation involves removing resultant precursor shaped abrasive particles 100A, 100B, or 100C from the mold cavities. The precursor shaped abrasive particle 100A, 100B, or 100C can be removed from the cavities by using the following processes alone or in combination on the mold: gravity, vibration, ultrasonic vibration, vacuum, or pressurized air to remove the particles from the mold cavities.

The precursor shaped abrasive particles 100A, 100B, or 100C can be further dried outside of the mold. If the precursor dispersion is dried to the desired level in the mold, this additional drying step is not necessary. However, in some instances it can be economical to employ this additional drying step to minimize the time that the precursor dispersion resides in the mold. The precursor shaped abrasive particle 100A, 100B, or 100C will be dried from 10 to 480 minutes, or from 120 to 400 minutes, at a temperature from 50° C. to 160° C., or 120° C. to 150° C.

A further operation involves calcining the precursor shaped abrasive particle 100A, 100B, or 100C. During calcining, essentially all the volatile material is removed, and the various components that were present in the precursor dispersion are transformed into metal oxides. The precursor shaped abrasive particle 100A, 100B, or 100C is generally heated to a temperature from 400° C. to 800° C. and maintained within this temperature range until the free water and over 90 percent by weight of any bound volatile material are removed. In an optional step, it can be desirable to introduce the modifying additive by an impregnation process. A water-soluble salt can be introduced by impregnation into the pores of the calcined, precursor shaped abrasive particles 100A, 100B, or 100C. Then the precursor shaped abrasive particle 100 are pre-fired again.

A further operation can involve sintering the calcined, precursor shaped abrasive particle 100A, 100B, or 100C to form particles 100A, 100B, or 100C. In some examples where the precursor includes rare earth metals, however, sintering may not be necessary. Prior to sintering, the calcined, precursor shaped abrasive particle 100A, 100B, or 100C are not completely densified and thus lack the desired hardness to be used as shaped abrasive particle 100A, 100B, or 100C. Sintering takes place by heating the calcined, precursor shaped abrasive particle 100A, 100B, or 100C to a temperature of from 1000° C. to 1650° C. The length of time for which the calcined, precursor shaped abrasive particle 100A, 100B, or 100C can be exposed to the sintering temperature to achieve this level of conversion depends upon various factors, but from five seconds to 48 hours is possible.

In another embodiment, the duration of the sintering step ranges from one minute to 90 minutes. After sintering, the shaped abrasive particle 100A, 100B, or 100C can have a Vickers hardness of 10 GPa (gigaPascals), 16 GPa, 18 GPa, 20 GPa, 25 GPa, or greater.

Additional operations can be used to modify the described process, such as, for example, rapidly heating the material from the calcining temperature to the sintering temperature, and centrifuging the precursor dispersion to remove sludge and/or waste. Moreover, the process can be modified by combining two or more of the process steps if desired.

In further embodiments, shaped abrasive particles 100A, 100B, or 100C can be formed through additive manufacturing.

Any of shaped abrasive particles 100A, 100B, 100C, or a mixture thereof can be included in an abrasive article such as a coated abrasive article. The coated abrasive article can be formed as a belt, a disc, or a sheet. A coated abrasive article includes substrate or backing 112. Shaped abrasive particles 100A, 100B, or 100C are adhered to a baking or substrate 112 by a make coat. Shaped abrasive particles 100A, 100B, or 100C can be further adhered to the make coat by a size coat or optional supersize coat. In some embodiments, Shaped abrasive particles 100A, 100B, or 100C are in full or partial contact with the make coat. Although a coated abrasive article is described, it is possible for any of shaped abrasive particles 100A, 100B, or 100C to be included in a bonded abrasive article or a woven abrasive article.

The make coat or the size coat can include any suitable adhesive material or resin. For example, the make coat, size coat, or both can include a phenolic resin, an epoxy resin, a urea-formaldehyde resin, an acrylate resin, an aminoplast resin, a melamine resin, an acrylated epoxy resin, a urethane resin, or mixtures thereof. The make coat, size coat or both can include an additive such as a filler (e.g., calcium carbonate, silica, talc, clay, calcium metasilicate, dolomite, aluminum sulfate, or a mixture thereof), a grinding aid, a wetting agent, a surfactant, a dye, a pigment, a coupling agent, an adhesion promoter, or a mixture thereof.

Shaped abrasive particles 100A, 100B, or 100C can be present in an abrasive article as the only shaped abrasive particles, in other embodiments however, shaped abrasive particles 100A, 100B, or 100C can be present as a blend of abrasive particles, which may include the same materials or different materials. For example, some abrasive articles can include a blend where shaped abrasive particles 100A, 100B, or 100C are present in a range of from about 5 wt % to about 99 wt % of the blend, about 50 wt % to about 95 wt % of the blend, less than, equal to, or greater than about 5 wt %, 10, 15, 20, 25, 30, 35, 40, 45, 50, 55, 60, 65, 70, 75, 80, 85, 90, 95, or about 95 wt % of the blend.

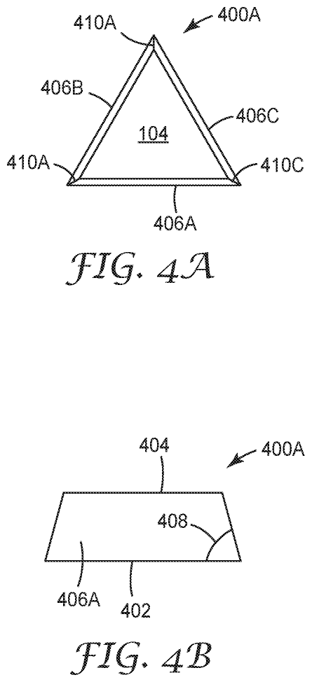

In some embodiments, the blend of abrasive particles can include abrasive particles shaped as an equilateral triangle conforming to a truncated pyramid. As shown in FIGS. 4A and 4B where the shaped abrasive particle 400 includes a truncated regular triangular pyramid bounded by a triangular base 402, a triangular top 404, and plurality of sloping sides 406A, 406B, 406C connecting triangular base 402 (shown as equilateral although scalene, obtuse, isosceles, and right triangles are possible) and triangular top 404. Slope angle 408A is the dihedral angle formed by the intersection of side 406A with triangular base 402. Similarly, slope angles 408B and 408C (both not shown) correspond to the dihedral angles formed by the respective intersections of sides 406B and 406C with triangular base 402. In the case of shaped abrasive particle 400, all of the slope angles have equal value. In some embodiments, side edges 406A, 406B, and 406C have an average radius of curvature in a range of from about 0.05 μm to about 80 μm, about 10 μm to about 60 μm, or less than, equal to, or greater than about 0.05 μm, 5, 10, 15, 20, 25, 30, 35, 40, 45, 50, 55, 60, 65, 70, 75, or about 80 μm.

In the embodiment shown in FIGS. 4A and 4B, sides 406A, 406B, and 406C have equal dimensions and form dihedral angles with the triangular base 402 of about 82 degrees (corresponding to a slope angle of 82 degrees). However, it will be recognized that other dihedral angles (including 90 degrees) may also be used. For example, the dihedral angle between the base and each of the sides may independently range from 45 to 90 degrees (for example, from 70 to 90 degrees, or from 75 to 85 degrees). Edges connecting sides 406, base 402, and top 404 can have any suitable length.

For example, a length of the edges may be in a range of from about 0.5 μm to about 2000 μm, about 150 μm to about 200 μm, or less than, equal to, or greater than about 0.5 μm, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000 μm.

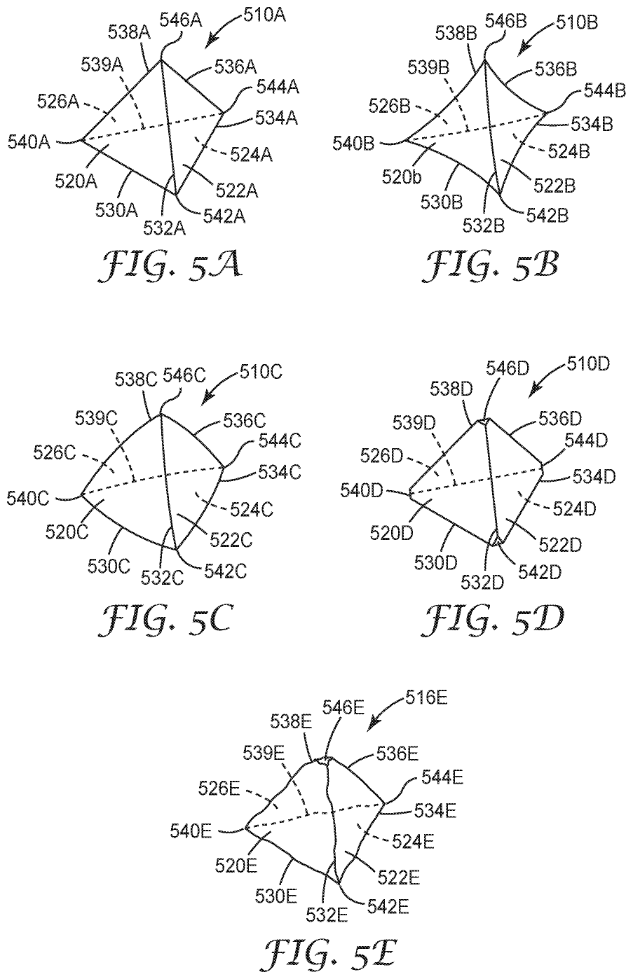

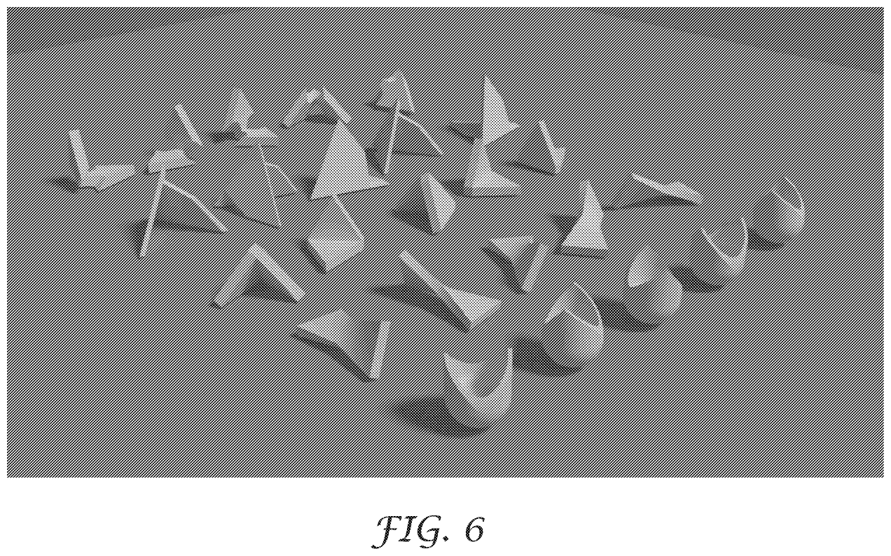

In some embodiments, the blend can include abrasive particles shaped as tetrahedral abrasive particles. As shown in FIGS. 5A-5E, shaped abrasive particles 500 are shaped as regular tetrahedrons. As shown in FIG. 5A, shaped abrasive particle 500A has four faces (520A, 522A, 524A, and 526A) joined by six edges (530A, 532A, 534A, 536A, 538A, and 539A) terminating at four vertices (540A, 542A, 544A, and 546A). Each of the faces contacts the other three of the faces at the edges. While a regular tetrahedron (e.g., having six equal edges and four faces) is depicted in FIG. 5A, it will be recognized that other shapes are also permissible. For example, tetrahedral abrasive particles 500 can be shaped as irregular tetrahedrons (e.g., having edges of differing lengths).

Referring now to FIG. 5B, shaped abrasive particle 500B has four faces (520B, 522B, 524B, and 526B) joined by six edges (530B, 532B, 534B, 536B, 538B, and 539B) terminating at four vertices (540B, 542B, 544B, and 546B). Each of the faces is concave and contacts the other three of the faces at respective common edges. While a particle with tetrahedral symmetry (e.g., four rotational axes of threefold symmetry and six reflective planes of symmetry) is depicted in FIG. 5B, it will be recognized that other shapes are also permissible. For example, shaped abrasive particles 500B can have one, two, or three concave faces with the remainder being planar.

Referring now to FIG. 5C, shaped abrasive particle 500C has four faces (520C, 522C, 524C, and 526C) joined by six edges (530C, 532C, 534C, 536C, 538C, and 539C) terminating at four vertices (540C, 542C, 544C, and 546C). Each of the faces is convex and contacts the other three of the faces at respective common edges. While a particle with tetrahedral symmetry is depicted in FIG. 5C, it will be recognized that other shapes are also permissible. For example, shaped abrasive particles 500C can have one, two, or three convex faces with the remainder being planar or concave.

Referring now to FIG. 5D, shaped abrasive particle 500D has four faces (520D, 522D, 524D, and 526D) joined by six edges (530D, 532D, 534D, 536D, 538D, and 539D) terminating at four vertices (540D, 542D, 544D, and 546D). While a particle with tetrahedral symmetry is depicted in FIG. 5D, it will be recognized that other shapes are also permissible. For example, shaped abrasive particles 500D can have one, two, or three convex faces with the remainder being planar.

Deviations from the depictions in FIGS. 5A-5D can be present. An example of such a shaped abrasive particle 500 is depicted in FIG. 5E, showing shaped abrasive particle 500E, which has four faces (520E, 522E, 524E, and 526E) joined by six edges (530E, 532E, 534E, 536E, 538E, and 539E) terminating at four vertices (540E, 542E, 544E, and 546E). Each of the faces contacts the other three of the faces at respective common edges. Each of the faces, edges, and vertices has an irregular shape.

The blend of abrasive particles can also include conventional (e.g., crushed) abrasive particles. Examples of useful abrasive particles include fused aluminum oxide-based materials such as aluminum oxide, ceramic aluminum oxide (which can include one or more metal oxide modifiers and/or seeding or nucleating agents), and heat-treated aluminum oxide, silicon carbide, co-fused alumina-zirconia, diamond, ceria, titanium diboride, cubic boron nitride, boron carbide, garnet, flint, emery, sol-gel derived abrasive particles, and mixtures thereof.

The conventional abrasive particles can, for example, have an average diameter ranging from about 10 μm to about 2000 μm, about 20 μm to about 1300 μm, about 50 μm to about 1000 μm, less than, equal to, or greater than about 10 μm, 20, 30, 40, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1650, 1700, 1750, 1800, 1850, 1900, 1950, or 2000 μm. For example, the conventional abrasive particles can have an abrasives industry-specified nominal grade. Such abrasives industry-accepted grading standards include those known as the American National Standards Institute, Inc. (ANSI) standards, Federation of European Producers of Abrasive Products (FEPA) standards, and Japanese Industrial Standard (HS) standards. Exemplary ANSI grade designations (e.g., specified nominal grades) include: ANSI 12 (1842 μm), ANSI 16 (1320 μm), ANSI 20 (905 μm), ANSI 24 (728 μm), ANSI 36 (530 μm), ANSI 40 (420 μm), ANSI 50 (351 μm), ANSI 60 (264 μm), ANSI 80 (195 μm), ANSI 100 (141 μm), ANSI 120 (116 μm), ANSI 150 (93 μm), ANSI 180 (78 μm), ANSI 220 (66 μm), ANSI 240 (53 μm), ANSI 280 (44 μm), ANSI 320 (46 μm), ANSI 360 (30 μm), ANSI 400 (24 μm), and ANSI 600 (16 μm). Exemplary FEPA grade designations include P12 (1746 μm), P16 (1320 μm), P20 (984 μm), P24 (728 μm), P30 (630 μm), P36 (530 μm), P40 (420 μm), P50 (326 μm), P60 (264 μm), P80 (195 μm), P100 (156 μm), P120 (127 μm), P120 (127 μm), P150 (97 μm), P180 (78 μm), P220 (66 μm), P240 (60 μm), P280 (53 μm), P320 (46 μm), P360 (41 μm), P400 (36 μm), P500 (30 μm), P600 (26 μm), and P800 (22 μm). An approximate average particles size of reach grade is listed in parenthesis following each grade designation.

The abrasive article can be manufactured according to many suitable methods. For example, a make coat or make coat precursor can be applied to substrate 112. Abrasive particles 100A, 100B, or 100C can be contacted with backing. Upon contact with substrate 112, make coat precursor, or both shaped abrasive particles 100A, 100B, or 100C achieve their stable resting position in which at least one vertex is oriented in an upward direction.

In some embodiments, it may be beneficial to arrange shaped abrasive particles to form a predetermined pattern or to achieve a desired z-direction rotational orientation. This can be achieved according to several suitable methods. For example, a predetermined pattern of shaped abrasive particles 100A, 100B, or 100C or a specific z-direction rotational orientation of shaped abrasive particles 100A, 100B, or 100C can be achieved through use of a precision apertured screen that positions shaped abrasive particles 100A, 100B, or 100C into a specific z-direction rotational orientation such that shaped abrasive particles 100A, 100B, or 100C can only fit into the precision apertured screen in a few specific orientations such as less than or equal to 4, 3, 2, or 1 orientations.

For example, a rectangular opening just slightly bigger than the cross section shaped abrasive particles 100A, 100B, or 100C comprising a rectangular plate will orient shaped abrasive particles 100A, 100B, or 100C in one of two possible 180 degree opposed z-direction rotational orientations. The precision apertured screen can be designed such that shaped abrasive particles 100A, 100B, or 100C, while positioned in the screen's apertures, can rotate about their z-axis (normal to the screen's surface when the formed abrasive particles are positioned in the aperture) less than or equal to about 30, 20, 10, 5, 2, or 1 angular degrees.

The precision apertured screen having a plurality of apertures selected to orient shaped abrasive particles 100A, 100B, or 100C into a pattern in the x-y plane, can have a retaining member such as adhesive tape on a second precision apertured screen with a matching aperture pattern, an electrostatic field used to hold the particles in the first precision screen or a mechanical lock such as two precision apertured screens with matching aperture patterns twisted in opposite directions to pinch shaped abrasive particles 100A, 100B, or 100C within the apertures. The first precision aperture screen is filled with shaped abrasive particles 100A, 100B, or 100C, and the retaining member is used to hold shaped abrasive particles 100A, 100B, and 100C in place in the apertures.

Following positioning in apertures, coated substrate 112 having a make layer is positioned parallel to the first precision aperture screen surface containing shaped abrasive particles 100A, 100B, or 100C with the make layer facing shaped abrasive particles 100A, 100B, or 100C in the apertures. Thereafter, the coated substrate 112 and the first precision aperture screen are brought into contact to adhere shaped abrasive particles 100A, 100B, or 100C to the make layer. The retaining member is released such as by removing the second precision aperture screen with taped surface, untwisting the two precision aperture screens, or eliminating the electrostatic field. Then the first precision aperture screen is then removed leaving shaped abrasive particles 100A, 100B, or 100C having a specified z-directional rotational orientation on the coated abrasive article for further conventional processing such as applying a size coat and curing the make and size coats. Another way to form an abrasive article in which shaped abrasive particles 100A, 100B, or 100C have a specified z-direction rotational angle or predetermined pattern is to use magnetic alignment. In some further embodiments, it may be desirable to expose shaped abrasive particles 100A, 100B, or 100C to a source of pressurized air. This can help to push shaped abrasive particles 100A, 100B, or 100C into a desired orientation or help to stand-up shaped abrasive particles that may tip over upon contact with the make coat. Additionally, after shaped abrasive particles 100A, 100B, and 100C are in contact with the make coat, the abrasive article can be vibrated to temporarily reduce the viscosity of the make coat to help shaped abrasive particles 100A, 100B, and 100C achieve their stable resting positions.

In the case of a coated abrasive article, the curable binder precursor comprises a make layer precursor, and the magnetizable particles comprise magnetizable abrasive particles. A size layer precursor may be applied over the at least partially cured make layer precursor and the magnetizable abrasive particles, although this is not a requirement. If present, the size layer precursor is then at least partially cured at a second curing station, optionally with further curing of the at least partially cured make layer precursor. In some embodiments, a supersize layer is disposed on the at least partially cured size layer precursor.

The specified z-direction rotational orientation of shaped abrasive particles 100A, 100B, 100C occurs more frequently than would occur by a random z-direction rotational orientation due to electrostatic coating or drop coating of the shaped abrasive particles 100A, 100B, 100C when forming the abrasive article. As such, by controlling the z-direction rotational orientation of a significantly large number of shaped abrasive particles 100A, 100B, 100C, the cut rate, finish, or both of coated abrasive article can be varied from those manufactured using an electrostatic coating method. In various embodiments, at least 50, 51, 55, 60, 65, 70, 75, 80, 85, 90, 95, or 99 percent of shaped abrasive particles 100A, 100B, 100C can have a specified z-direction rotational orientation which does not occur randomly, and which can be substantially the same for all of the aligned particles. In other embodiments, about 50 percent of shaped abrasive 100A, 100B, 100C can be aligned in a first direction and about 50 percent of shaped abrasive 100A, 100B, 100C can be aligned in a second direction. In one embodiment, the first direction is substantially orthogonal to the second direction.

According to various embodiments, a method of using an abrasive article including abrasive particles 100A, 100B, 100C, or a mixture thereof includes contacting shaped abrasive particles 100A, 100B, or 100C with a workpiece or substrate. The workpiece or substrate can include many different materials such as steel, steel alloy, aluminum, plastic, wood, organic materials, or a combination thereof. Upon contact, one of the abrasive article and the workpiece is moved relative to one another and a portion of the workpiece is removed.

During use, at least one of vertices 114 can be fractured. Fracturing vertices 114 can lead to the generation of one or more new vertices, thus creating self-sharpening abrasive particles. Upon fracturing the properties of the previous vertex 114 is largely retained in the new vertex. For example, in some embodiments, a radius of curvature of previous vertex 114 and new vertex 114 is substantially the same. In some embodiments, the radius of curvature of the fractured new vertex 114 is substantially smaller than the radius of the curvature of the original vertex 114. In some embodiments a cross-sectional shape of previous vertex 114 and new vertex 114 may be substantially the same. It may be possible to generate new vertices over a wide range of abrasive grinding cycles before shaped abrasive particles are unable to generate new vertices.

### EXAMPLES

Various embodiments of the present disclosure can be better understood by reference to the following Examples which are offered by way of illustration. The present disclosure is not limited to the Examples given herein.

### Example 1

### Orientation Study

A simulation was run using computer rendered shaped abrasive particles 100A, 100B, and 100C to determine what percentage of particles oriented on a planar substrate in an upright position. In a computer simulated drop test, five types of embodiments of particles 100A, 100B, and 100C were dropped on to a flat substrate to demonstrate the ability of these particles to self-orient such that when they land on the substrate, they settle and rest on their stable position under gravitational force only with at least one vertex pointing upward or substantially upward. The simulation was performed using Blender, a free 3D animation software by the Blend Foundation. FIG. 6 is a screenshot showing the shaped abrasive particles in their resting position. In their resting position, all these particles have at least one vertex pointing upward. To run a drop test simulation in Blender, the solid models of embodiments of particles 100A, 100B, and 100C in the format of STL were imported into Blender. A rigid plane was created in Blender to represent the substrate 112 upon which the solid models of the embodiments of particles 100A, 100B, and 100C were dropped. The particles were modeled as linear elastic bodies. In the simulation, the particles were dropped from a height of 20 mm measured from the substrate 112. The simulation was performed using the Blender Game Physics Engine. Upon the completion of the drop test simulation, one of Blender's built-in rendering engines was used to create an animation of the simulation.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

Embodiment 1 provides a shaped abrasive particle comprising:

a first non-planar continuous surface;

a second non-planar continuous surface;

at least one sidewall or edge joining the first non-planar continuous surface and the second non-planar continuous surface; and

one or more vertices;

the shaped abrasive particle configured to have a stable resting position on a substantially planar substrate, wherein at least one vertex is oriented in a substantially upward direction relative to the planar substrate.

Embodiment 2 provides the shaped abrasive particle of Embodiment 1, wherein the shaped abrasive particle comprises a ceramic, a glass, a rare earth oxide, a polymer, or a mixture thereof.

Embodiment 3 provides the shaped abrasive particle of any one of Embodiments 1 or 2, wherein the shaped abrasive particle comprises alpha alumina, sol-gel derived alpha alumina, or a mixture thereof.

Embodiment 4 provides the shaped abrasive particle of any one of Embodiments 1-3, wherein the shaped abrasive particles comprises a fused aluminum oxide, a heat-treated aluminum oxide, a ceramic aluminum oxide, a sintered aluminum oxide, a silicon carbide material, a titanium diboride, a boron carbide, a tungsten carbide, a titanium carbide, a diamond, a cubic boron nitride, a garnet, a fused alumina-zirconia, a cerium oxide, a zirconium oxide, a titanium oxide or a combination thereof.

Embodiment 5 provides the shaped abrasive particle of any one of Embodiments 1-4, wherein a radius of curvature of the one or more vertices is independently in a range of from about 0.1 microns to about 500 microns.

Embodiment 6 provides the shaped abrasive particle of any one of Embodiments 1-5, wherein a radius of curvature of the one or more vertices is independently in a range of from about 0.5 microns to 40 microns.

Embodiment 7 provides the shaped abrasive particle of any one of Embodiments 1-6, wherein a minimum thickness of the shaped abrasive particle defined between the first non-planar surface and the second non-planar surface is in a range of from about 0.005 mm to 5 mm.

Embodiment 8 provides the shaped abrasive particle of any one of Embodiments 1-7, wherein a minimum thickness of the shaped abrasive particle defined between the first non-planar surface and the second non-planar surface is in a range of from about 0.02 mm to 2 mm.

Embodiment 9 provides the shaped abrasive particle of any one of Embodiments 1-8, wherein the first non-planar continuous surface, the second non-planar continuous surface, or both are curved.

Embodiment 10 provides the shaped abrasive particle of any one of Embodiments 1-9, wherein the particle comprises a generally cylindrical shape.

Embodiment 11 provides the shaped abrasive particle of Embodiment 10, wherein the generally cylindrical shape comprises a centered hollow interior.

Embodiment 12 provides the shaped abrasive particle of any one of Embodiments 10 or 11, wherein the generally circular cross-sectional shape comprises a symmetric circular shape or an asymmetric circular shape.

Embodiment 13 provides the shaped abrasive particle of any one of Embodiments 9-12, wherein the first and second non-planar continuous surfaces comprises a curved region and a generally linear region.

Embodiment 14 provides the shaped abrasive particle of Embodiment 13, wherein the curved region comprises 5 percent surface area to about 70 percent surface area of the shaped abrasive particle.

Embodiment 15 provides the shaped abrasive particle of any one of Embodiments 13 or 14, wherein the curved region comprises 25 percent surface area to about 50 percent surface area of the shaped abrasive particle.

Embodiment 16 provides the shaped abrasive particle of any one of Embodiments 13-15, wherein the curved region comprises a hemi-spherical shape.

Embodiment 17 provides the shaped abrasive particle of any one of Embodiments 13-16, wherein the linear region comprises 5 percent surface area to about 70 percent surface area of the shaped abrasive particle.

Embodiment 18 provides the shaped abrasive particle of any one of Embodiments 13-17, wherein the linear region comprises 25 percent surface area to about 50 percent surface area of the shaped abrasive particle.

Embodiment 19 provides the shaped abrasive particle of any one of Embodiments 13-18, wherein the linear region comprises the one or more vertices.

Embodiment 20 provides the shaped abrasive particle of any one of Embodiments 13-19, wherein a center of gravity of the shaped abrasive particle is located within the curved region.

Embodiment 21 provides the shaped abrasive particle of Embodiment 20, wherein the center of gravity is not located at a geometric center of the shaped abrasive particle.

Embodiment 22 provides the shaped abrasive particle of any one of Embodiments 13-21, wherein the curved region comprises a bottom end of the shaped abrasive particle and the linear region comprises a top end of the shaped abrasive particle.

Embodiment 23 provides the shaped abrasive particle of Embodiment 22, wherein the one or more vertices are located at the top end of the shaped abrasive particle.

Embodiment 24 provides the shaped abrasive particle of any one of Embodiments 22 or 23, wherein the bottom end of the shaped abrasive particle is in contact with the planar substrate at its stable resting position.

Embodiment 25 provides the shaped abrasive particle of any one of Embodiments 9-24, wherein a distance between a vertex and the planar substrate is greater than a distance between the planar substrate and the center of gravity.

Embodiment 26 provides the shaped abrasive particle of any one of Embodiments 9-25, wherein the distance between a vertex and the planar substrate is at least 101% greater than the distance between the planar substrate and the center of gravity

Embodiment 27 provides the shaped abrasive particle of any one of Embodiments 1-8, wherein at least one of the first non-planar continuous surface and the second non-planar continuous surface comprise a twist.

Embodiment 28 provides the shaped abrasive particle of Embodiment 27, wherein the twist is located between a first region of at least one of the first non-planar continuous surface and the second non-planar continuous surface and a second region of at least one of the first non-planar continuous surface and the second non-planar continuous surface.

Embodiment 29 provides the shaped abrasive particle of any one of Embodiments 1-28, wherein a thickness of the shaped abrasive particle is non-uniform.

Embodiment 30 provides the shaped abrasive particle of any one of Embodiments 28 or 29, wherein the first region and the second region are twisted about a longitudinal axis of the shaped abrasive particle at an angle in a range from about 5 degrees to about 170 degrees with respect to each other.

Embodiment 31 provides the shaped abrasive particle of any one of Embodiments 28-30, wherein the first region and the second region are twisted about a longitudinal axis of the shaped abrasive particle at an angle in a range from about 20 degrees to about 90 degrees with respect to each other.

Embodiment 32 provides the shaped abrasive particle of any one of Embodiments 28-31, wherein the first region and the second region independently comprise 5 percent surface area to about 95 percent surface area of the shaped abrasive particle.

Embodiment 33 provides the shaped abrasive particle of any one of Embodiments 28-32, wherein the first region and the second region independently comprise 25 percent surface area to about 50 percent surface area of the shaped abrasive particle.

Embodiment 34 provides the shaped abrasive particle of any one of Embodiments 28-33, wherein the at least one sidewall is tapered.

Embodiment 35 provides the shaped abrasive particle of any one of Embodiments 28-34, wherein the shaped abrasive particle comprises a varying cross-sectional area across a length of the shaped abrasive particle.

Embodiment 36 provides the shaped abrasive particle of any one of Embodiments 28-35, wherein the first region and the second region independently comprise a rectangular or trapezoidal cross-sectional shape.

Embodiment 37 provides the shaped abrasive particle of any one of Embodiments 28-36, wherein the first region and the second region independently comprise a triangular cross-sectional shape.

Embodiment 38 provides the shaped abrasive particle of any one of Embodiments 28-37, wherein the shaped abrasive particle comprises at least four vertices.

Embodiment 39 provides the shaped abrasive particle of Embodiment 38, wherein in the resting position three vertices are in contact with the planar substrate.

Embodiment 40 provides the shaped abrasive particle of any one of Embodiments 38 or 39, wherein in the resting position, a distance between a vertex and the planar substrate is greater than a distance between the planar substrate and the center of gravity.

Embodiment 41 provides the shaped abrasive particle of any one of Embodiments 38-40, wherein the distance between a vertex and the planar substrate is at least 101% greater than a distance between the planar substrate and the center of gravity.

Embodiment 42 provides the shaped abrasive particle of any one of Embodiments 28-41, wherein the shaped abrasive article is bent at a dihedral angle in a range of from about 70 degrees to about 179 degrees.

Embodiment 43 provides the shaped abrasive particle of Embodiment 42, wherein the shaped abrasive article is bent at a dihedral angle in a range of from about 95 degrees to about 110 degrees.

Embodiment 44 provides the shaped abrasive particle of any one of Embodiments 42 or 43, wherein the dihedral angle is measured between a first region of at least one of the first non-planar continuous surface and the second non-planar continuous surface and a second region of at least one of the first non-planar continuous surface and the second non-planar continuous surface.

Embodiment 45 provides the shaped abrasive particle of Embodiment 28-44, wherein a thickness of the shaped abrasive particle is non-uniform.

Embodiment 46 provides the shaped abrasive particle of any one of Embodiments 44 or 45, wherein the shaped abrasive particle comprises a varying cross-sectional area across a length of the shaped abrasive particle.

Embodiment 47 provides the shaped abrasive particle of any one of Embodiments 44-46, wherein the first region and the second region comprise a polygonal profile.

Embodiment 48 provides the shaped abrasive particle of Embodiment 47, wherein the polygonal profile is chosen from a triangle, a square, a rectangle, a trapezoid, a pentagon, a hexagon, a heptagon, or an octagon, or a shape consisting the combination of polygonal shapes including triangles, squares, rectangles, trapezoids, pentagons, hexagons, heptagon, octagons.

Embodiment 49 provides the shaped abrasive particle of any one of Embodiments 44-48, wherein the first region of the first non-planar continuous surface or the second non-planar continuous surface; the second region of the first non-planar continuous surface or the second non-planar continuous surface; or a combination thereof, are substantially planar.

Embodiment 50 provides the shaped abrasive particle of any one of Embodiments 44-49, wherein in the stable resting position the first region or the second region is in contact with the substantially planar substrate.

Embodiment 51 provides the shaped abrasive particle of any one of Embodiments 44-50, wherein the first region and the second region independently comprise 5 percent surface area to about 95 percent surface area of the shaped abrasive particle.

Embodiment 52 provides the shaped abrasive particle of any one of Embodiments 44-51, wherein the first region and the second region independently comprise 25 percent surface area to about 50 percent surface area of the shaped abrasive particle.

Embodiment 53 provides the shaped abrasive particle of any one of Embodiments 44-52, wherein in the stable resting position, the sidewalls are in contact with the substantially planar surface.

Embodiment 54 provides the shaped abrasive particle of any one of Embodiments 50-53, wherein in the stable resting position, a distance between a vertex and the planar substrate is greater than a distance between the planar substrate and the center of gravity.

Embodiment 55 provides the shaped abrasive particle of Embodiment 54, a distance between a vertex and the planar substrate is at least 101% greater than a distance between the planar substrate and the center of gravity.

Embodiment 56 provides a shaped abrasive particle comprising:
a curved portion;
a linear portion extending from the curved portion, the linear portion defining at least one vertex,
   wherein a center of gravity of the abrasive particle is located in the curved portion.

Embodiment 57 provides a twisted shaped abrasive particle comprising:
a first portion comprising a first edge defining first and second vertices; and
a second portion connected to the first portion and comprising a second edge defining third and fourth vertices;
   wherein the first portion is twisted relative to the second portion such that only three of the first, second, third and fourth vertices can be located in a single plane.

Embodiment 58 provides a bent shaped abrasive particle comprising:
a first portion comprising a first edge defining a first vertex; and
a second portion connected to the first portion and comprising a second edge defining a second vertex;
   wherein the first portion is bent relative to the second portion such that a dihedral angle between the first portion and the second portion is in a range of from about 45 degrees to about 179 degrees.

Embodiment 59 provides a method of making the shaped abrasive particle of any one of Embodiments 1-58, the method comprising:

disposing an abrasive particle precursor composition in a cavity of a mold, the cavity conforming to the negative image of the shaped abrasive particle; and

drying the abrasive particle precursor to form the shaped abrasive particle.

Embodiment 60 provides the method of Embodiment 59, further comprising twisting the mold about an axis of the mold.

Embodiment 61 provides the method of Embodiment 60, wherein the mold is twisted before the abrasive particle precursor is dried.

Embodiment 62 provides the method of any one of Embodiments 59-61, further comprising removing the shaped abrasive particle from the cavity.

Embodiment 63 provides a method of making the shaped abrasive particle of any one of Embodiments 1-58, the method comprising extruding the abrasive particle precursor through a die.

Embodiment 64 provides the method of Embodiment 63, further comprising actuating the die from a first position to a second position during extrusion.

Embodiment 65 provides a method of making the shaped abrasive particle of any one of Embodiments 1-58, the method comprising:

additively manufacturing the shaped abrasive particle.

Embodiment 66 provides an abrasive article comprising:

a backing; and

a plurality of the shaped abrasive particle of any one of Embodiments 1-58 or manufactured according to the methods of any one of Embodiments 59-65 attached to the backing.

Embodiment 67 provides the abrasive article of Embodiment 66, wherein the article comprises a blend of the shaped abrasive particles and crushed abrasive particles.

Embodiment 68 provides the abrasive article of Embodiment 67, wherein the shaped abrasive particles and the crushed abrasive particles comprise the same material or mixture of materials.

Embodiment 69 provides the abrasive article of any one of Embodiments 67 or 68, wherein the shaped abrasive particles are in a range of from about 5 wt % to about 99 wt % of the blend.

Embodiment 70 provides the abrasive article of any one of Embodiments 67-69, wherein the shaped abrasive particles are in a range of from about 50 wt % to about 95 wt % of the blend.

Embodiment 71 provides the abrasive article of any one of Embodiments 66-70, wherein the abrasive article comprises a belt, a disc, or a sheet.

Embodiment 72 provides the abrasive article of any one of Embodiments 66-71, further comprising a make coat adhering the shaped abrasive particles to the backing.

Embodiment 73 provides the abrasive article of Embodiment 72, further comprising a size coat adhering the shaped abrasive particles to the make coat.

Embodiment 74 provides the abrasive article of any one of Embodiments 72 or 73, wherein at least one of the make coat and the size coat comprise a phenolic resin, an epoxy resin, a urea-formaldehyde resin, an acrylate resin, an aminoplast resin, a melamine resin, an acrylated epoxy resin, a urethane resin, or mixtures thereof.

Embodiment 75 provides the abrasive article of any one of Embodiments 72-74, wherein at least one of the make coat and the size coat comprises a filler, a grinding aid, a wetting agent, a surfactant, a dye, a pigment, a coupling agent, an adhesion promoter, or a mixture thereof.

Embodiment 76 provides the abrasive article of Embodiment 75, wherein the filler comprises calcium carbonate, silica, talc, clay, calcium metasilicate, dolomite, aluminum sulfate, or a mixture thereof.

Embodiment 77 provides a method of making the abrasive article of any one of Embodiments 66-76, the method comprising:

orienting the shaped abrasive particles; and

adhering the shaped abrasive particles to the backing.

Embodiment 78 provides the method of Embodiment 77, wherein orienting the shaped abrasive particles comprises dropping the shaped abrasive particles on the backing and allowing the shaped abrasive particles to achieve a stable resting position without further assistance.

Embodiment 79 provides a method of using the abrasive article according to any one of Embodiments 61-76 or made according to the method of any one of Embodiments 77 or 78, the method comprising:

contacting the shaped abrasive particles with a workpiece;

moving at least one of the abrasive article and the workpiece relative to each other; and

removing a portion of the workpiece.

Embodiment 80 provides the method of Embodiment 79, further comprising fracturing at least one of the vertices of the shaped abrasive particles.

Embodiment 81 provides the method of Embodiment 80, wherein one or more new vertices are generated upon fracturing.

Embodiment 82 provides the method of Embodiment 81, wherein a cross-sectional shape of the one or more new vertices is substantially the same as the cross-sectional shape of the original one or more vertices.

1. A shaped abrasive particle comprising:
a first non-planar continuous surface;
a second non-planar continuous surface;
at least one sidewall or edge joining the first non-planar continuous surface and the second non-planar continuous surface; and
one or more vertices;
the shaped abrasive particle configured to have a stable resting position on a substantially planar substrate, wherein at least one vertex is oriented in a substantially upward direction relative to the planar substrate.

2. The shaped abrasive particle of claim 1, wherein the first non-planar continuous surface, the second non-planar continuous surface, or both are curved.

3. The shaped abrasive particle of claim 1, wherein the first and second non-planar continuous surfaces comprises a curved region and a generally linear region.

4. The shaped abrasive particle of claim 3, wherein the linear region comprises the one or more vertices.

5. The shaped abrasive particle of claim 1, wherein the distance from the one or more vertices to the planar substrate surface is greater than the distance from the center of gravity of the particle to a substrate surface when the particle is at its stable resting position.

6. The shaped abrasive particle of claim 1, wherein at least one of the first non-planar continuous surface and the second non-planar continuous surface comprise a twist.

7. The shaped abrasive particle of claim 1, wherein the twist is located between a first region of at least one of the first non-planar continuous surface and the second non-planar continuous surface and a second region of at least one of the first non-planar continuous surface and the second non-planar continuous surface.

8. The shaped abrasive particle of claim 7, wherein the first region and the second region are twisted about a longitudinal axis of the shaped abrasive particle at an angle in a range from about 5 degrees to about 170 degrees with respect to each other.

9. The shaped abrasive particle of claim 7, wherein in the resting position three vertices are in contact with the planar substrate.

10. The shaped abrasive particle of claim 7, wherein in the resting position, the distance measured from a vertex to a substrate is greater than the distance measured from the center of gravity of the shaped abrasive particle to the substrate surface.

11. The shaped abrasive particle of claim 1, wherein the shaped abrasive article is bent at a dihedral angle in a range of from about 45 degrees to about 179 degrees.

12. The shaped abrasive particle of claim 11, wherein the dihedral angle is measured between a first region of at least one of the first non-planar continuous surface and the second non-planar continuous surface and a second region of at least one of the first non-planar continuous surface and the second non-planar continuous surface.

13. The shaped abrasive particle of claim 11, wherein in the resting position the first region, the second region, or both are in contact with the substantially planar substrate.

14. The shaped abrasive particle of claim 11, wherein in the resting position, the sidewalls are in contact with the substantially planar surface.

15. A method of making the shaped abrasive particle of claim 1, the method comprising:
disposing an abrasive particle precursor composition in a cavity of a mold, the cavity conforming to the negative image of the shaped abrasive particle; and
drying the abrasive particle precursor to form the shaped abrasive particle.
